(19) United States
(12) Patent Application Publication
(10) Pub. No.: US 2016/0295286 A1
(43) Pub. Date: Oct. 6, 2016

(54) BROADCAST RECEIVING APPARATUS AND CONTROL METHOD THEREOF

(71) Applicant: SAMSUNG ELECTRONICS CO., LTD., Suwon-si (KR)

(72) Inventors: Jun Seok KANG, Incheon (KR); Young Jin LEE, Suwon-si (KR); Kyoung Shin JIN, Yongin-si (KR)

(73) Assignee: SAMSUNG ELECTRONICS CO., LTD., Suwon-si (KR)

(21) Appl. No.: 15/086,312

(22) Filed: Mar. 31, 2016

(30) Foreign Application Priority Data
Mar. 31, 2015 (KR) 10-2015-0044894

(51) Int. Cl. H04N 21/482; H04N 21/45

(52) U.S. Cl. CPC H04N 21/482; H04N 21/4524

(57) ABSTRACT

A broadcast receiving apparatus is provided. The broadcast receiving apparatus includes: a signal receiver configured to receive a broadcast signal carrying a plurality of channels; a communicator configured to communicate with a server that provides channel information of the broadcast signal according to a plurality of locations; a storage configured to store the channel information; and at least one processor configured to determine a location corresponding to the broadcast receiving apparatus, receive the channel information of the broadcast signal corresponding to the determined location and store the received channel information in the storage.

### CROSS-REFERENCE TO RELATED THE APPLICATION

This application claims priority from Korean Patent Application No. 10-2015-0044894 filed on Mar. 31, 2015 in the Korean Intellectual Property Office, the disclosure of which is incorporated herein by reference in its entirety.

### BACKGROUND

1. Field

Apparatuses and methods consistent with the exemplary embodiments relate to a broadcast receiving apparatus capable of being tuned to and receiving a broadcast signal received from an exterior and processing the broadcast signal to be displayed as a broadcast image and a control method thereof, and more particularly to a broadcast receiving apparatus improved in acquiring a channel map used when being tuned to a broadcast signal and a control method thereof.

2. Description of the Related Art

An image processing apparatus processes a video signal/video data received from an external device in accordance with various video processing processes. The image processing apparatus may display an image based on the processed video data on its own display panel, or output the processed video signal to another broadcast receiving apparatus provided with a panel so that the corresponding broadcast receiving apparatus can display an image based on the processed video signal. That is, the image processing apparatus may include the panel capable of displaying an image or include no panel as long as it can process the video data and transfer the processed video data to another apparatus to display. For example, the former may include a television (TV), and the latter may include a set-top box. Among these image processing apparatuses, an apparatus for receiving a broadcast signal from a transmitter of a broadcasting station and processing it to be displayed as a broadcast image is called a broadcast receiving apparatus.

Fundamentally, the broadcast signal has an effective frequency band, and channels are assigned to respective frequency bands divided within this effective frequency band. Thus, the broadcast receiving apparatus is tuned to a frequency of a channel carried by a broadcast signal in order to display a broadcast image of the channel designated by a user. Therefore, the broadcast receiving apparatus has to be informed of a tuning frequency assigned to each channel before being tuned to the frequency, and this tuning frequency information will be called a channel map. That is, the broadcast receiving apparatus needs to acquire and store the channel map of the broadcast signal to be received and processed.

Conventionally, the broadcast receiving apparatus has used a full-scanning method in order to acquire the channel map. In the full-scanning method, the broadcast receiving apparatus scans the whole effective frequency band of the broadcast signal by itself, and generates the channel map based on the scanning results.

With regard to broadcasting systems according to locations, the Americas and Europe have the same system in satellite broadcasting or cable broadcasting, but have different systems in terrestrial broadcasting. The terrestrial broadcasting in Europe employs an algorithm in which automatic scanning is performed jumping in units of 1 MHz.

The full-scanning method has high accuracy of the information in the channel map because the broadcast receiving apparatus directly scans the currently received broadcast signals and determines the frequencies assigned to the channels. However, the full-scanning method takes a long time to build the channel map because the effective frequency band has to be fully scanned. In particular, recent broadcast signal carries more than hundreds of channels, and therefore the time for the full-scanning method may be significant.

To shorten the time required to perform the full scan, various methods may be used. However, there is a limitation to shorten the time required for scanning because of constraints on time, such as lock time and time-out.

### SUMMARY

According to an aspect of an exemplary embodiment, there is provided a broadcast receiving apparatus comprising: a signal receiver configured to receive a broadcast signal carrying a plurality of channels; a communicator configured to communicate with a server that provides channel information of the broadcast signal according to a plurality of locations; a storage configured to store the channel information; and at least one processor configured to determine a location corresponding to the broadcast receiving apparatus, receive the channel information of the broadcast signal corresponding to the determined location and store the received channel information in the storage, and receive data from one channel of the plurality of channels carried by the broadcast signal based on the stored channel information. Thus, it is possible to easily acquire the channel information, i.e. the channel map without using the full scanning method.

The communicator may be configured to wirelessly communicate with a communication relay for relaying communication with a network, and the at least one processor may determine the location based on access information given from the communication relay to the communicator so that the communicator can access the network. The communication relay may comprise an access point and a router for relaying wireless communication, and the access information may comprise an Internet protocol (IP) address given from the access point and the router to the broadcast receiving apparatus. Thus, it is easy to have conditions for accurately specifying the location.

The at least one processor may process a user interface (UI) to be displayed for allowing a user to select one of locations identified by the access information. Thus, a user can easily select a certain location if the plurality of locations are specified.

The at least one processor may scan the broadcast signal with regard to a preset number of channels from the received channel information, and store the channel information in response to the scanning result being equal to the channel information. Thus, it is possible to test validity about whether the received channel information is accurate.

The at least one processor may generate channel information by fully scanning an effective frequency band of the broadcast signal in response to the scanning result being different from the channel information. Thus, the channel information is newly acquired using the full scanning method even though the received channel information is not accurate.

The at least one processor may extract channel information by scanning a preset frequency band within an effective frequency band of the broadcast signal in response to receiving a plurality of pieces of the channel information corresponding to the location, and select one piece of channel information, which has the scanned channel information, among the plurality of pieces of the channel information. Thus, it is possible to select the channel information suitable for the current broadcast signal when the plurality of pieces of the channel information are received.

The at least one processor may determine the location in response to a user's input.

The at least one processor may determine whether the channel information is received before fully scanning the effective frequency band of the broadcast signal.

According to an aspect of an exemplary embodiment, there is provided a control method of a broadcast receiving apparatus. The method comprises: communicating with a server that proves channel information of a broadcast signal according to a plurality of locations; determining a location corresponding to the broadcast receiving apparatus; receiving the channel information of the broadcast signal corresponding to the determined location and storing the received channel information in the storage; and receiving data from a channel carried by the broadcast signal based on the stored channel information. Thus, it is possible to easily acquire the channel information, i.e. the channel map without using the full scanning method.

The determining the location may comprise: accessing a communication relay for relaying communication with a network; and determining the location based on access information given from the communication relay so that the broadcast receiving apparatus can have access to the network. The communication relay may comprise an access point and a router for relaying wireless communication, and the access information may comprise an Internet protocol (IP) address given from the access point and the router to the broadcast receiving apparatus. Thus, it is easy to have conditions for accurately specifying the location.

The determining the location may comprise: displaying a user interface (UI) for allowing a user to select one of the locations if there are a plurality of locations identified by the access information. Thus, a user can easily select a certain location identified by the access information.

The receiving and storing the channel information may comprise: scanning the broadcast signal with regard to a preset number of channels from the received channel information; and storing the channel information in response to the scanning result being equal to the channel information. Thus, it is possible to test validity about whether the received channel information is accurate.

The receiving and storing the channel information may comprise: generating channel information by fully scanning an effective frequency band of the broadcast signal in response to the scanning result being different from the channel information. Thus, the channel information is newly acquired using the full scanning method even though the received channel information is not accurate.

The receiving and storing the channel information may comprise: extracting channel information by scanning a preset frequency band within an effective frequency band of the broadcast signal in response to receiving a plurality of pieces of the channel information corresponding to the location; and selecting one piece of channel information, which has the scanned channel information, among the plurality of pieces of the channel information. Thus, it is possible to select the channel information suitable for the current broadcast signal when the plurality of pieces of the channel information are received.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates a system according to an exemplary embodiment;

FIG. 2 is a block diagram of a broadcast receiving apparatus in the system of FIG. 1;

FIG. 3 is a block diagram of a processor in the broadcast receiving apparatus of FIG. 2;

FIG. 4 illustrates channels arranged within an effective frequency band of a broadcast signal received in the broadcast receiving apparatus of FIG. 2;

FIG. 5 illustrates a user interface (UI), which shows a progress of full channel scanning, displayed on the broadcast receiving apparatus of FIG. 2;

FIG. 6 illustrates a UI, which allows a user to change a network setting, displayed on the broadcast receiving apparatus of FIG. 2;

FIG. 7 illustrates a UI, which shows locational information corresponding to IP address, displayed on the broadcast receiving apparatus of FIG. 2;

FIG. 8 is a flowchart showing a control method of the broadcast receiving apparatus of FIG. 2;

FIG. 9 illustrates that the broadcast receiving apparatus of FIG. 2 exchanges data with a location identifying server and a channel-map providing server;

FIG. 10 is a flowchart showing a method of acquiring the channel map from the channel-map providing server in the broadcast receiving apparatus of FIG. 2;

FIG. 11 is a flowchart showing a control method of a broadcast receiving apparatus according to an exemplary embodiment;

FIG. 12 illustrates data communication between a broadcast receiving apparatus and a channel-map providing server according to an exemplary embodiment;

FIG. 13 is a flowchart showing a control method of the broadcast receiving apparatus according to an exemplary embodiment;

FIG. 14 illustrates a principle of acquiring a channel map in a broadcast receiving apparatus according to an exemplary embodiment;

FIG. 15 is a flowchart showing a control method of the broadcast receiving apparatus according to an exemplary embodiment;

FIG. 16 illustrates a principle of acquiring a channel map in a broadcast receiving apparatus according to an exemplary embodiment;

FIG. 17 is a flowchart showing a control method of the broadcast receiving apparatus according to an exemplary embodiment;

FIG. 18 illustrate a UI, which requests a user to select a location, displayed on a broadcast receiving apparatus according to an exemplary embodiment;

FIG. 19 is a flowchart showing a control method of the broadcast receiving apparatus according to an exemplary embodiment;

FIG. 20 illustrates that a broadcast receiving apparatus according to an exemplary embodiment receives broadcast signals from respective transmitters of broadcasting stations;

FIG. 21 is a flowchart showing a control method of the broadcast receiving apparatus according to an exemplary embodiment;

FIG. 22 illustrates a UI, which requests a user's approval for change of a broadcast signal, displayed on a broadcast receiving apparatus according to an exemplary embodiment;

FIG. 23 is a flowchart showing a control method of the broadcast receiving apparatus according to an exemplary embodiment; and

FIG. 24 is a flowchart showing a control method of a broadcast receiving apparatus according to an exemplary embodiment.

### DETAILED DESCRIPTION OF EXEMPLARY EMBODIMENTS

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms, such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the invention.

Further, the exemplary embodiments will describe only elements directly related to the idea of the invention, and description of the other elements will be omitted. However, it will be appreciated that the elements, the descriptions of which are omitted, are not unnecessary to realize the apparatus or system according to the exemplary embodiments. In the following descriptions, terms such as “include” or “have” refer to presence of features, numbers, steps, operations, elements or combination thereof, and do not exclude presence or addition of one or more other features, numbers, steps, operations, elements or combination thereof.

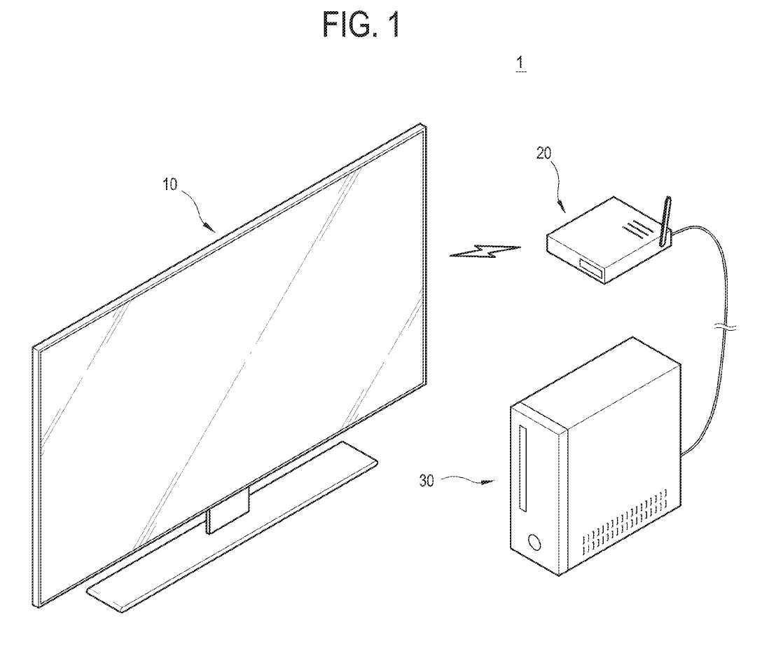

FIG. 1 illustrates a system 1 according to an exemplary embodiment.

As shown in FIG. 1, the system 1 according to this exemplary embodiment includes a broadcast receiving apparatus 10, an access point (AP) 20 wirelessly communicating with the broadcast receiving apparatus 10, and a router 30 to which the AP 20 is connected.

The broadcast receiving apparatus 10 is an apparatus for receiving a broadcast signal from a transmitter of a broadcasting station, which can be generally achieved by an image processing apparatus or a display apparatus. The broadcast receiving apparatus 10 may be variously achieved. For example, the broadcast receiving apparatus 10 may be a television (TV) that processes a broadcast signal and displays the processed broadcast signal as a broadcast image, or may be a set-top box that processes a broadcast signal and outputs the processed broadcast signal to a TV so that the TV can display the broadcast image.

The broadcast receiving apparatus 10 may receive a broadcast signal through various methods, for example, a radio frequency (RF) antenna, a satellite antenna, a cable, etc. The broadcast receiving apparatus 10 may perform various functions in addition to receiving and processing the broadcast signal. For example, the broadcast receiving apparatus may display an image received from an external device, such as a digital versatile disc (DVD)/Blu-ray disc (BD) player, or may access a wide area network (WAN) through the AP 20.

The AP 20 has a communication enabled range within a radius of a preset distance, i.e. a hot-spot, and wirelessly connects with one or more clients, such as the broadcast receiving apparatus 10 within the hot-spot. The hot-spot of the AP 20 may be extended by a repeater (not shown) or the like. Basically, the AP 20 complies with institute of electrical and electronics engineers (IEEE) 802.11 and operates based on an infrastructure mode of Wi-Fi and other wireless communication standards.

The AP 20 is connected to the wide area network through the wire-connected router 30, so that the client connected to the AP 20 can access the wide area network. Because the client has to be within the hot-spot of the AP 20 in order to access the AP 20 and perform communication, a mobile device may not be able to continuously access the AP 20. Thus, the broadcast receiving apparatus 10 in this embodiment may be a stationarily installed apparatus.

With this structure of the system 1, the broadcast receiving apparatus 10 could access and communicate with the wide area network through the AP 20. The broadcast receiving apparatus 10 has to get an internet protocol (IP) address from the AP 20 in order to interactively communicate with the wide area network. The broadcast receiving apparatus 10 may receive and store information, such as WPS, wireless Internet service providers (WISP), service set identifiers (SSID), etc. from the AP 20. The WPS is to specify the position of the AP 20, the WISP is to specify a network network/Internet service provider, and the SSID is to identify the AP 20.

Below, the IP address will be described.

The IP address is a specific number used by apparatuses to recognize and communicate with each other in a computing network. All the apparatuses connected to the network need this specific number. Using this number, a message could be sent from a sender and transmitted to a predetermined destination. The IP address is sometimes called ‘IP’, but has to be strictly separated from IP since the IP refers to Internet protocol itself.

The IP address is an identification address logically designated on a network layer, and the apparatus connected to Internet has one or more addresses for identification. The IP address is assigned to an interface rather than the apparatus itself. The IP address is an address for identifying a destination network for IP routing.

The IP address is an address used for specifying a communication target in a local area network (LAN), a wide area network (WAN) and Internet. In general, it is difficult for a user to memorize this address. Therefore, if the IP address is compared to a phone number, there is a need of a service acting as a phone book. Domain name system (DNS) works like the phone book, and this service will be also called a domain name resolution or a name resolution. The IP address usually used nowadays is IP version 4 (IPv4) but is becoming scarce. Therefore, lengthened IP version 6 (IPv6) has been also widely used. The IP address is given to the broadcast receiving apparatus 10 in the form of a static IP address or a dynamic IP address using a dynamic host configuration protocol (DHCP).

Recently, the IPv4 address has been usually used as the IP address. This address is 32 bits long, and is represented by four decimal numbers each of which ranges from 0 to 255 and which are separated by dots. Theoretically, there are 4294967296 different IP addresses from 0.0.0.0 to 255.255.255.255. Further, some numbers of the IP addresses are reserved for special purposes. For example, 127.0.0.1 indicates that the apparatus itself is a local host.

The IPv6 address lengthens the IP address from 32 bits to 128 bits because the IPv4 address becomes scarce. The IPv6 address is usually represented by eight double-digit hexadecimal numbers separated by “:”.

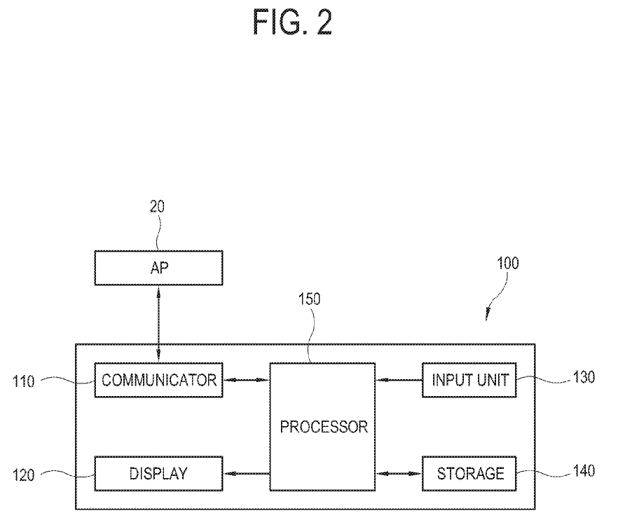

Below, the elements of the broadcast receiving apparatus 10 will be described with reference to FIG. 2.

FIG. 2 is a block diagram of a broadcast receiving apparatus 100. The broadcast receiving apparatus 100 of FIG. 2 is substantially the same as the broadcast receiving apparatus 10 of FIG. 1.

As shown in FIG. 2, the broadcast receiving apparatus 100 according to this embodiment is a TV that can display a broadcast image. However, the broadcast receiving apparatus 100 may be an apparatus capable of receiving the broadcast signal. Alternatively, the broadcast receiving apparatus 100 may be achieved by an apparatus that cannot display a broadcast image, such as a set-top box.

The broadcast receiving apparatus 100 includes a communicator 110 that performs communication to exchange data/signal with an external device, a display 120 that displays an image based on data if the data received in the communicator 110 corresponds to a video signal, a user input unit 130 that receives a user's input operations, a storage 140 that stores data, and a processor 150 that controls general operations of the broadcast receiving apparatus 100 and processes data.

The communicator 110 transmits/receives data locally or through a network so that the broadcast receiving apparatus 100 can interactively communicate with an external device. The communicator 110 may be achieved by an assembly of connection ports or connection modules based on respective communication standards and supportable protocols, and communication targets are not limited to one kind or type. For example, the communicator 110 may include a tuner for being tuned to a broadcast signal, a wi-fi communication module for wireless communication with an access point (AP) 20, an Ethernet module for separate wired connection, and a universal serial bus (USB) port for connection with a USB storage device.

The display 120 displays an image based on a video signal processed by the processor 150. For example, the display 120 displays a broadcasting image based on the tuned broadcast signal output from the processor 150. There are no limitations to the types of the display 120. For example, the display 120 may be achieved by a liquid crystal display, a plasma display, a light-emitting diode display, an organic light-emitting diode display, a surface-conduction electron emitter display, a carbon nano-tube display, a nano-crystal display, etc.

The display 120 may include additional elements in accordance with its types. For example, if the display 120 is achieved by a liquid crystal display, the display 130 includes a liquid crystal display (LCD) panel, a backlight unit for supplying light to the LCD panel, and a panel driving substrate for driving the LCD panel.

The input unit 130 transmits various preset control commands or information to the processor 150 in accordance with a user's control or input. The input unit 130 changes various events, which occurs by a user's control in accordance with a user's intention, into information and transmits the information to the processor 150. The input unit 130 may be variously achieved in accordance with information input methods. For example, the input unit 130 may include an external key/button provided outside the broadcast receiving apparatus 100, a separate remote controller separated from the broadcast receiving apparatus 100, and a touch screen formed integrally with the display 120.

The storage 140 stores various pieces of data under process and control of the processor 150. The storage 140 is accessed by the processor 315 and performs reading, writing, editing, deleting, updating or the like with regard to data. The storage 140 is achieved by a flash-memory, a hard-disc drive or any other nonvolatile memory to preserve data.

The processor 150 performs various processes with regard to data/signal received in the communicator 110. When a video signal is received in the communicator 110, the processor 150 performs an image processing process on the video signal, and outputs the processed video signal to the display 120, thereby displaying an image on the display 120.

There are no limitations to the type of image processing process performed by the processor 150, and the video processing process may include de-multiplexing for separating an input signal into sub-signals, such as video, audio and additional data, decoding video data into image formats of video signal, de-interlacing for converting image data from an interlaced type into a progressive type, scaling the video signal to adjust a resolution of the video signal, noise reduction for improving image quality, detail enhancement, frame refresh rate conversion, etc.

Because the processor 150 can perform various processes in accordance with the type and characteristic of data, the process performable by the processor 150 is not limited to the image processing process. Further, data processed by the processor 150 is not limited to only data received in the communicator 110. For example, if a user's voice is input to the broadcast receiving apparatus 100, the processor 150 may process the voice in accordance with a preset voice processing process. The processor 150 is achieved by a system-on-chip (SOC), in which many functions are integrated, or an image processing board where individual chip-sets for independently performing the processes are mounted to a printed circuit board. Thus, the broadcast receiving apparatus 100 has a built-in processor 150.

According to this exemplary embodiment, the processor 150 may be tuned to a frequency of a certain channel with regard to the broadcast signal and display a broadcast image based on the broadcast signal of the tuned frequency. If a command for selecting a certain channel is issued through the input unit 130 while the communicator 110 receives the broadcast signal, the processor 150 acquires a tuning frequency of the channel selected by the issued command. The processor 150 is tuned to the acquired tuning frequency of the broadcast signal and processes the broadcast signal corresponding to the tuning frequency, thereby displaying the broadcast image on the display 120.

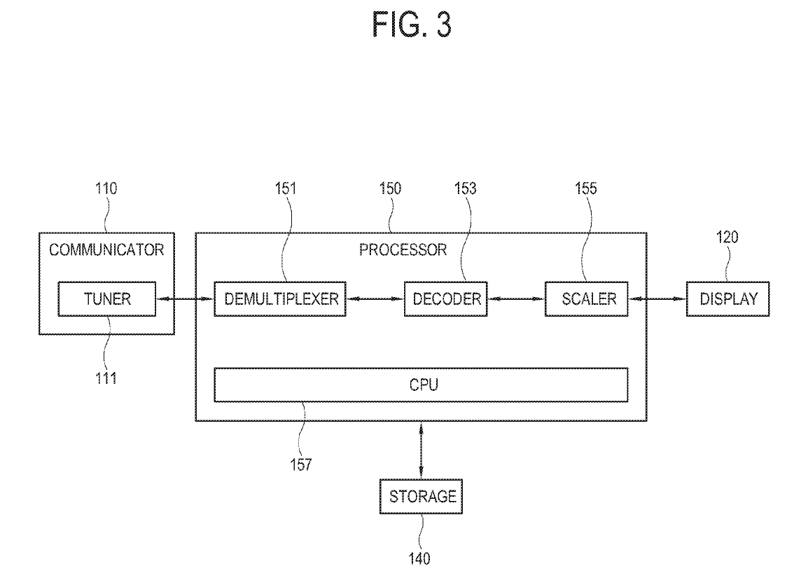

Below, detailed elements of the processor 150 will be described with reference to FIG. 3.

FIG. 3 is a block diagram of the processor 150 shown in FIG. 2. In FIG. 3, only basic elements are illustrated among the actual elements of the processor 150, and thus the actual product may further include other elements in addition to the elements to be described below.

As shown in FIG. 3, the communicator 110 includes a tuner 111 to be tuned to a certain frequency of a received broadcast signal. Further, the processor 150 includes a demultiplexer 151 that de-multiplexes a broadcast signal received by the tuner 111 of the communicator 110 into sub signals and processes the sub signals; a decoder 153 that decodes the sub signals output from the demultiplexer 151; a scaler 155 that scales a video signal among the decoded sub signals and outputs the scaled video signal to the display 120; and a central processing unit (CPU) 157 that performs calculation and control for operations of the processor 150.

If an RF broadcast signal is received in an external antenna, the tuner 111 is tuned to a frequency of a certain channel designated by the processor 150 with regard to the received broadcast signal and converts the broadcast signal into a transport stream. The tuner 111 includes a channel decoder and an A/D converter, and converts an analog signal into a digital transport stream. Alternatively, the tuner 111 may be designed differently from the foregoing embodiment. For example, the A/D converter may not be included in the tuner 111 but in a demodulator.

The demultiplexer (or deMUX) 151 performs a reverse operation of the multiplexer. That is, the demultiplexer 151 connects one input terminal with a plurality of output terminals, and distributes a stream input to the input terminal to the respective output terminals in accordance with selection signals. For example, if there are four output terminals with respect to one input terminal, each of the four output terminals may be selected by combination of selection signals having two levels of 0 and 1.

In the case where the demultiplexer 151 is applied to the broadcast receiving apparatus 100, the demultiplexer 151 divides the transport stream received from the tuner 111 into the sub signals of a video stream, an audio stream and a data stream and outputs the sub signals to the respective output terminals.

In an exemplary embodiment, the demultiplexer 151 may use various methods to divide the transport stream into the sub signals. For example, the demultiplexer 151 divides the transport stream into the sub signals in accordance with packet identifiers (PID) given to packets in the transport stream. The sub signals in the transport stream are independently compressed and packetized according to channels, and the same PID is given to the packets corresponding to one channel so as to be distinguished from the packets corresponding to another channel. The demultiplexer 151 classifies the packets in the transport stream according to the PID, and extracts the sub signals having the same PID.

The decoder 153 decodes each of the sub signals output from the demultiplexer 151. This exemplary embodiment shows one decoder 153, but a plurality of decoders 153 may be provided to decode the sub signals, respectively. That is, the decoder 153 may include a video decoder for decoding a video signal, an audio decoder for decoding an audio signal, and a data decoder for decoding data.

The sub signal transmitted to the decoder 153 is in an encoded state of a certain format, and thus the decoder 153 performs an opposite process to the encoding process with regard to the sub signal to thereby perform a decoding process for returning the sub signal to a state before the encoding process. Therefore, if the sub signal output from the demultiplexer 151 is not encoded, i.e. not compressed, this sub signal is not subject to the process of the decoder 153 and is directly transmitted to the scaler 155. Therefore, this sub signal may be transmitted to the scaler 155 by bypassing the decoder 153.

The scaler 155 scales the video signal decoded by the decoder 153 in accordance with the resolution of the display 120 or a separately designated resolution. The scaled video signal is displayed on the display 120.

The CPU 157 is an element for performing central calculation to operate general elements in the processor 150, and plays a central role in basically parsing and calculating data. The CPU 157 internally includes a processor register in which commands to be processed are stored; an arithmetic logic unit (ALU) being in charge of comparison, determination and calculation; a control unit for internally controlling the CPU 157 to analyze and carry out the commands; an internal bus, a cache, etc. Further, the CPU 157 externally includes a random access memory (RAM) as a nonvolatile memory to which data to be processed is loaded.

With this configuration, the processor 150 may be tuned to a broadcast signal and displays a broadcast image based on the received broadcast signal.

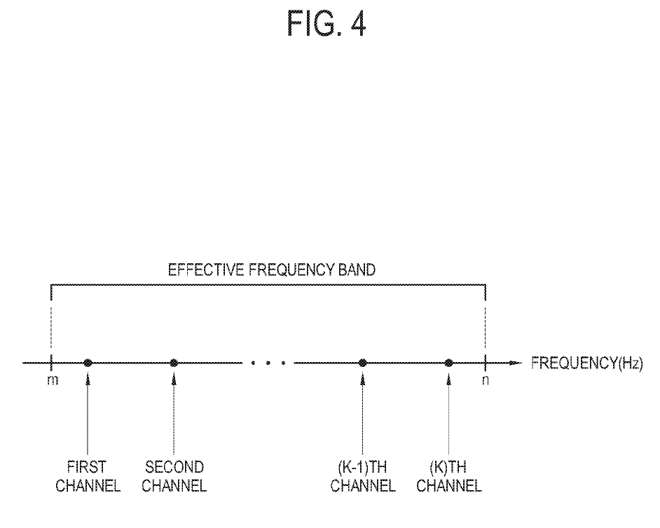

FIG. 4 illustrates channels arranged within an effective frequency band of a broadcast signal.

As shown in FIG. 4, the broadcast signal has an effective frequency band between the minimum value m and the maximum value n on a horizontal axis of frequency (Hz). The effective frequency band refers to an allowable frequency range in which channels of the broadcast signal are arranged.

If the broadcast signal includes a total of k channels, the channels respectively occupy unique frequency bands, which are not overlapped with one another in the effective frequency band. In FIG. 4, the first to the kth channels are arranged in sequence, but not limited thereto. That is, frequency arrangement does not depend on channel numbers. Further, FIG. 4 illustrates that one channel corresponds to a certain value within the effective frequency band, but not limited thereto. Alternatively, one channel may correspond to a certain band within the effective frequency band.

For example, each channel individually occupies a frequency band within the effective frequency band of the broadcast signal, and therefore the frequency band assigned to a desired channel has to be obtained to allow the broadcast receiving apparatus 100 to be tuned to the desired channel of the broadcast signal. Thus, the processor 150 previously acquires information about a frequency of each channel in the broadcast signal and stores the information in the storage 140. This information is typically called a channel map, and the channel map may further include information about a channel name, a channel provider, a channel content, etc. as well as the information about a frequency corresponding to a channel number.

The channel map is basically given in the form of a table where a channel number and its frequency value are tabulated. The channel number is a natural number to be easily recognized by a user. A user may input a desired channel number by operating numeral keys or channel up/down keys on the input unit 130.

The processor 150 acquires a frequency value corresponding to a channel number input through the input unit 130 from the channel map, and performs a process to be tuned to the acquired frequency value of the broadcast signal. Thus, the processor 150 can process a broadcast image corresponding to a channel desired by a user.

In addition, the broadcast receiving apparatus 100 may use various methods to acquire the channel map. For instance, the broadcast receiving apparatus 100 may use an automatic scanning method or a full scanning method. The full scanning method is that the broadcast receiving apparatus 100 scans the whole effective frequency band of the broadcast signal to acquire the frequency values of the respective channels, thereby generating and storing the channel map. The full scanning method may be used anytime to generate the channel map. For example, the channel map may be generated at an initial setting service for the broadcast receiving apparatus 100.

The initial setting service may be carried out when a user turns on the broadcast receiving apparatus 100 after purchase at the first time if the broadcast receiving apparatus 100 is a consumer electronics (CE) product that she/he executes an initial setting to set for his/her use environments. Basically, the initial setting service is executed in the form of a user interface (UI) that allows a user to input the setting values suitable for his/her use environments or adjust a default setting with regard to various functions of the broadcast receiving apparatus 100.

The broadcast receiving apparatus 100 may have various functions, which can be set through the initial setting service, such as selection of an external signal receiving mode, selection of a communication mode, input of communication network information, full channel scanning for generating a channel map, etc.

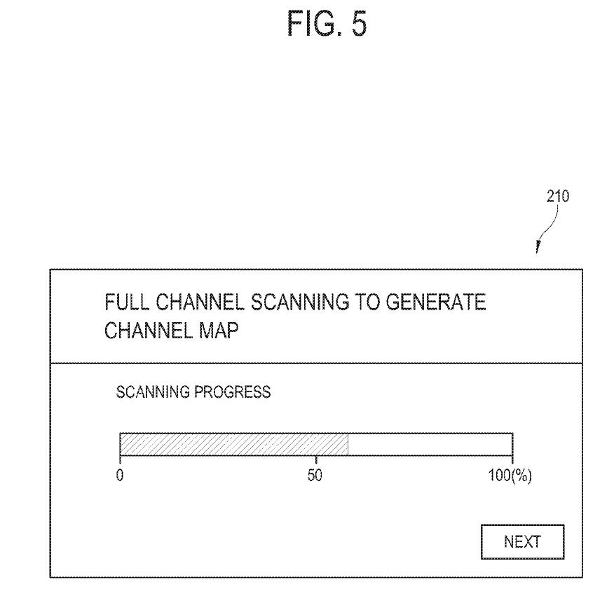

FIG. 5 illustrates a user interface (UI) 210, which shows a progress of full channel scanning, displayed on the broadcast receiving apparatus 100.

As shown in FIG. 5, the broadcast receiving apparatus 100 displays the UI 210 for fully scanning the effective frequency band of the broadcast signal during the initial setting service. Of course, the UI 210 may be displayed by selection of a user as well as the initial setting service. A user may select the UI 210 to be displayed at a desired point of time, when an event of changing a broadcast signal occurs, so that the channel map can be updated.

In addition, the full-scanning method has a high accuracy but has a problem because it takes a long time to scan the whole effective frequency band. In particular, time required for the full scanning method increases as the increasing number of channels included in the broadcast signal.

Accordingly, a method of controlling the broadcast receiving apparatus 100 to acquire the channel map within a relatively short time will be described below.

In the foregoing initial setting service, the broadcast receiving apparatus 100 performs a network setting for network communication. The network setting may be automatically carried out as the broadcast receiving apparatus 100 determines an external connection state of the communicator 110 (see FIG. 2) or may be changed by a user through a given UI.

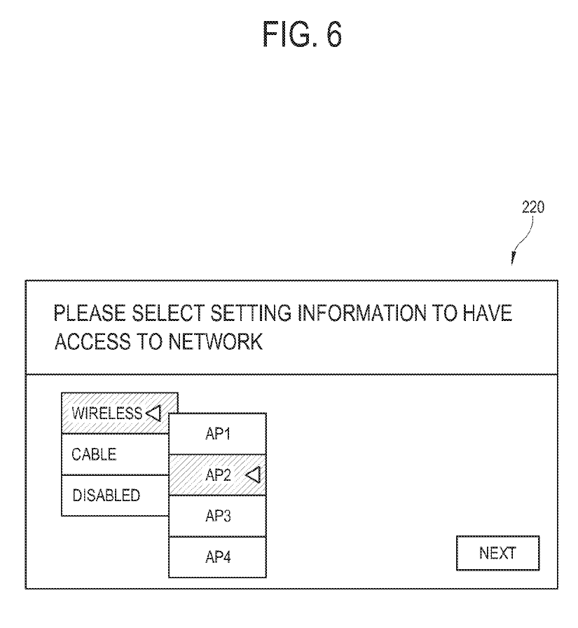

FIG. 6 illustrates a UI 220, which allows a user to change a network setting, displayed on the broadcast receiving apparatus 100.

As shown in FIG. 6, the broadcast receiving apparatus 100 displays the UI 220, which allows a user to change the network setting at the initial setting service. The UI 220 provides a user with a wireless or wired network connection method. If a user selects the wireless connection method through the UI 220 and the broadcast receiving apparatus 100 is located within the hot-spot for the plurality of access points (AP), the UI 220 may provide the plurality of access points to be selectable.

If a user selects the wireless connection method and an AP through the UI 220, the broadcast receiving apparatus 100 accesses the AP and acquires the IP address, thereby completing the wireless network connection.

At this time, the broadcast receiving apparatus 100 accesses a preset location identifying server. The location identifying server stores database (DB) including address information of a location corresponding to an IP address. The broadcast receiving apparatus 100 transmits the acquired IP address to the location identifying server and receives locational information corresponding to this ID address from the location identifying server. Here, the location may refer to a preset unit location, a national unit location or a segmental location, such as a city in a nation. Further, the location may be segmented based on an administrative district or may be segmented for convenience by other methods.

Such a DB has been previously built up and provided in the location identifying server, and an address for accessing the location identifying server may be transmitted to the broadcast receiving apparatus 100 through various methods so that the broadcast receiving apparatus 100 can access the location identifying server. For example, the broadcast receiving apparatus 100 may have the address for accessing the location identifying server in its manufacturing stage, or may acquire the address for accessing the location identifying server from a support server.

The broadcast receiving apparatus 100 receives the locational information from the location identifying server, and accesses a preset channel-map providing server. The channel-map providing server stores the DB including the channel maps respectively corresponding to the plurality of locations. Basically, the broadcast signals are different in arrangement and contents of channels according to unit locations, and therefore the channel maps are also different according to the unit locations.

The broadcast receiving apparatus 100 transmits the acquired locational information to the channel-map providing server, and receives and stores the channel map corresponding to the locational information from the channel-map providing server.

Thus, the broadcast receiving apparatus 100 requires less time to acquire the channel map than the time taken by the full scanning method.

Further, the broadcast receiving apparatus 100 may ask a user about whether the locational information is correct at a point of time when this locational information corresponding to the IP address is acquired from the location identifying server.

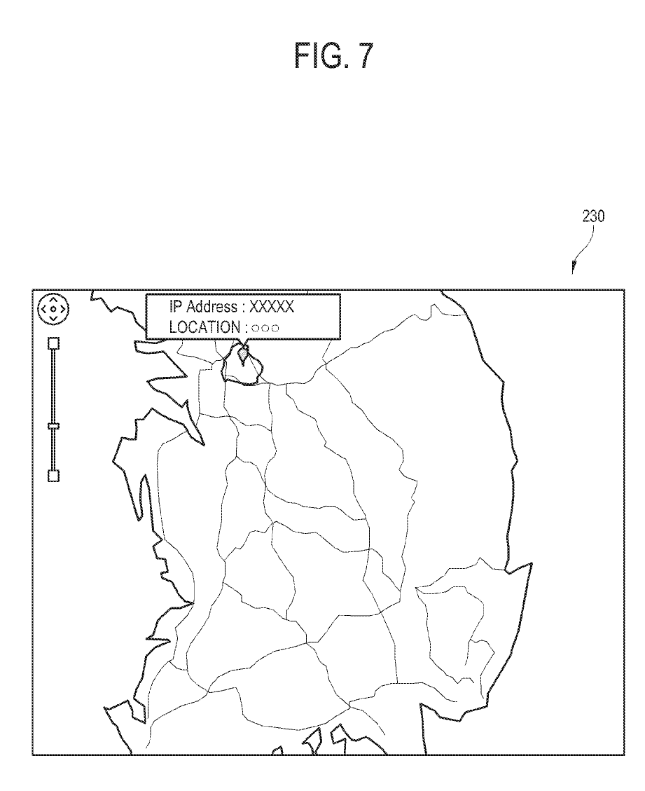

FIG. 7 illustrates a UI 230, which shows locational information corresponding to IP address, displayed on the broadcast receiving apparatus 100.

As shown in FIG. 7, if the broadcast receiving apparatus 100 receives the locational information from the IP address, the broadcast receiving apparatus 100 may display the UI 230 showing the IP address and the locational information and request a user's approval before transmitting this locational information to the channel-map providing server.

The UI 230 may be variously designed. For example, the UI 230 may be designed to mark a location corresponding to the locational information on a map and show the IP address and the locational information in the form of pop-up messages to be easily recognized by a user.

If a user approves of the locational information through the UI 230, the broadcast receiving apparatus 100 transmits the locational information to the channel-map providing server.

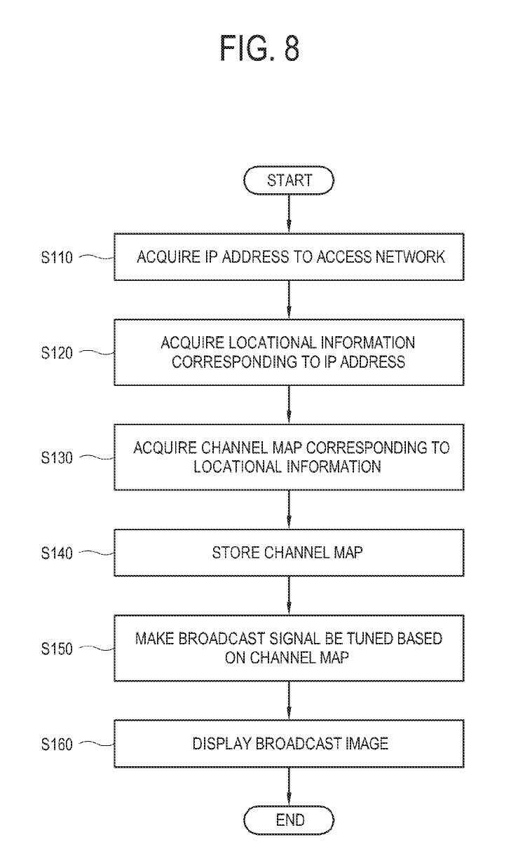

Below, the control method of the broadcast receiving apparatus 100 according to an exemplary embodiment will be described with reference to FIG. 8.

FIG. 8 is a flowchart showing a control method of the broadcast receiving apparatus 100 according to an exemplary embodiment.

As shown in FIG. 8, at operation S110, the broadcast receiving apparatus 100 acquires an IP address for accessing the network. If the broadcast receiving apparatus 100 desires to communicate through a wireless communication based on Wi-Fi, the broadcast receiving apparatus 100 acquires the IP address from the selected and connected AP.

At operation S120 the broadcast receiving apparatus 100 acquires the locational information corresponding to the IP address. As described above, the broadcast receiving apparatus 100 may acquire the locational information from the location identifying server where the locational information respectively corresponding to various IP addresses is stored. Alternatively, the broadcast receiving apparatus 100 may analyze the IP address by itself and derive the corresponding locational information without communicating with the location identifying server.

At operation S130, the broadcast receiving apparatus 100 obtains the channel map corresponding to the locational information. The channel map is provided from the channel-map providing server, where the channel map is stored corresponding to various locations, to the broadcast receiving apparatus 100.

At operation S140, the broadcast receiving apparatus 100 stores the channel map. At operation S150, the broadcast receiving apparatus 100 makes the broadcast signal be tuned based on the stored channel map.

At operation S160, the broadcast receiving apparatus 100 processes the received broadcast signal and displays a broadcast image based on the processed broadcast signal.

In this manner, the broadcast receiving apparatus 100 according to an exemplary embodiment acquires the channel map to be tuned to the broadcast signal.

Then, the broadcast receiving apparatus 100 periodically updates the channel map every three months or six months or the like while a broadcast image is not being displayed. Here, the time when the broadcast image is not being displayed refers to time when the tuner 111 (see FIG. 3) is not tuned to the broadcast signal even though the broadcast receiving apparatus 100 is turned on. For example, the time when the broadcast image is not being displayed may include time when, instead of an image provided from the broadcast signal, an image provided from a DVD/Blu-ray player is displayed, time when an external input, such as HDMI, AV port, etc. is used, time when a game is played, time when web surfing is implemented through Internet, and so on.

The channel map may be updated by the broadcast receiving apparatus 100 through the foregoing process in the background without being recognized by a user, and the broadcast receiving apparatus 100 may perform only the operations S130 and S140 if it is determined that the locational information is not changed from the previous process.

Further, if the broadcast receiving apparatus 100 has an enough system resource, the broadcast receiving apparatus 100 may perform the full scanning method in the background without being recognized by a user.

When the channel map is completely updated, the broadcast receiving apparatus 100 may display a message of informing the update completion for a preset time, while displaying a broadcast image based on a broadcast signal tuned by the tuner 111 (see FIG. 3). This message includes change in the channel map.

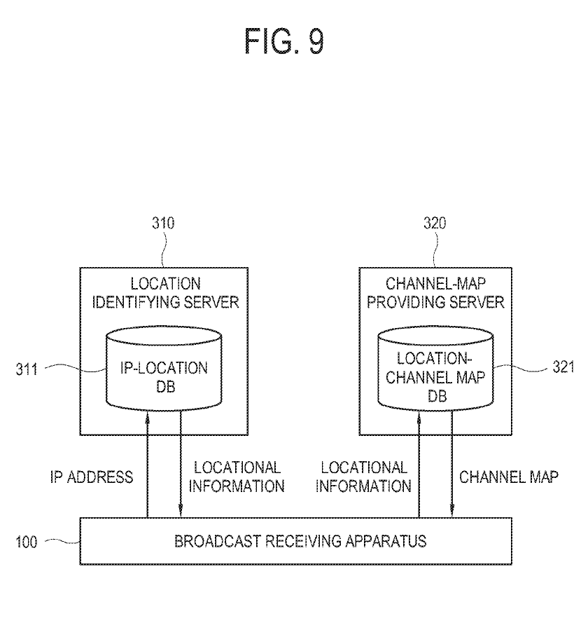

FIG. 9 illustrates that the broadcast receiving apparatus 100 exchanges data with a location identifying server 310 and a channel-map providing server 320.

As shown in FIG. 9, the broadcast receiving apparatus 100 can communicate with each of the location identifying server 310 and the channel-map providing server 320 through a network. Here, the location identifying server 310 stores IP addresses and builds up and stores an IP-location DB 311 including the locational information corresponding to the IP addresses, and the channel-map providing server 320 includes the locational information and builds up and stores a location-channel map DB 321 including the channel map corresponding to the locational information.

The broadcast receiving apparatus 100 acquires the IP address through the network setting and is thus capable of communicating with the location identifying server 310 and the channel-map providing server 320. First, the broadcast receiving apparatus 100 transmits its own IP address to the location identifying server 310. The location identifying server 310 searches the locational information corresponding to the IP address of the broadcast receiving apparatus 100 from the IP-location DB 311, and returns the locational information as a search result to the broadcast receiving apparatus 100.

Next, the broadcast receiving apparatus 100 transmits the locational information received from the location identifying server 310 to the channel-map providing server 320. The channel-map providing server 320 searches the channel map corresponding to the locational information received from the broadcast receiving apparatus 100 from the location-channel map DB 321, and returns the channel map as a search result to the broadcast receiving apparatus 100. Thus, the broadcast receiving apparatus 100 can acquire the channel map specified by the location.

During this procedure, the broadcast receiving apparatus 100 may not receive desired information. For example, there may be no locational information corresponding to the IP address of the broadcast receiving apparatus 100 in the IP-location DB 311 or there may be no channel map corresponding to the locational information of the broadcast receiving apparatus 100 in the location-channel map DB 321. In this case, the location identifying server 310 or the channel-map providing server 320 notifies the broadcast receiving apparatus 100 that no search results are found. Because the broadcast receiving apparatus 100 cannot acquire the channel map in this case, the broadcast receiving apparatus 100 may notify a user of this situation or may generate the channel map through the full scanning method.

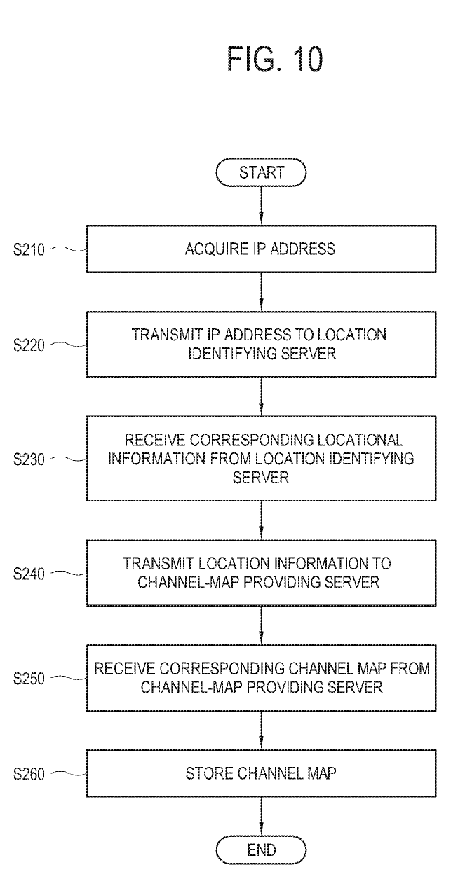

FIG. 10 is a flowchart showing a method of acquiring the channel map from the channel-map providing server 320 in the broadcast receiving apparatus 100.

As shown in FIG. 10, at operation S210, the broadcast receiving apparatus 100 acquires the IP address and accesses the network.

At operation S220, the broadcast receiving apparatus 100 sends the location identifying server 310 the IP address. At operation S230, the broadcast receiving apparatus 100 receives the corresponding locational information from the location identifying server 310.

At operation S240, the broadcast receiving apparatus 100 transmits the locational information to the channel-map providing server 320. At operation S250, the broadcast receiving apparatus 100 receives the corresponding channel map from the channel-map providing server 320. At operation S260, the broadcast receiving apparatus 100 stores the received channel map.

In the foregoing embodiment, the broadcast receiving apparatus 100 acquires the locational information corresponding to the IP address and acquires the channel map corresponding to the locational information, so that the channel map can be stored and directly used. However, the broadcast signal currently transmitted from the transmitter of the broadcasting station may not be matched with contents of the channel map provided by the channel-map providing server.

For example, if contents of a channel included in a broadcast signal transmitted from the transmitter of the broadcasting station are changed with respect to a first point of time, the channel-map providing server updates the channel map with the changed contents at a second point of time after the first point of time. In addition, if the broadcast receiving apparatus 100 receives the channel map from the channel-map providing server at a certain point of time between the first point of time and the second point of time, the channel map received in the broadcast receiving apparatus 100 is not matched with the broadcast signal received in the broadcast receiving apparatus 100.

Therefore, the broadcast receiving apparatus 100 may need to determine validity of the channel map after receiving the channel map, and this will be described below.

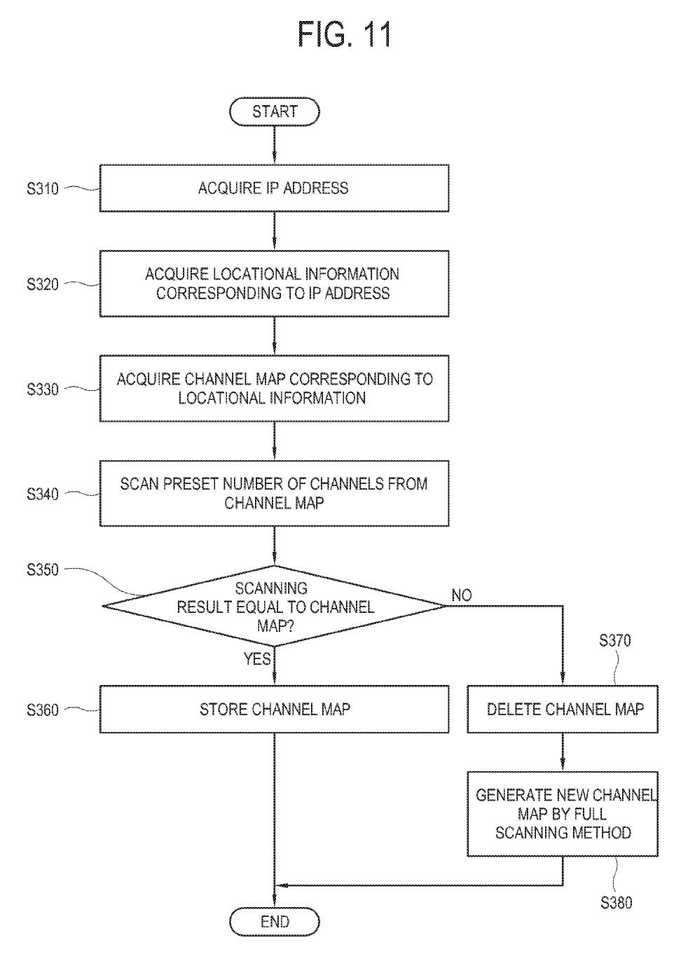

FIG. 11 is a flowchart showing a control method of a broadcast receiving apparatus 100 according to an exemplary embodiment.

As shown in FIG. 11, at operation S310, the broadcast receiving apparatus 100 acquires the IP address to access the network. At operation S320, the broadcast receiving apparatus 100 acquires the locational information corresponding to the IP address. At operation S330, the broadcast receiving apparatus 100 acquires the channel map corresponding to the locational information. The foregoing operations S310 to S330 are substantially the same as the operations S110 to S130 of the previous exemplary embodiment described with reference to FIG. 8.

At operation S340, the broadcast receiving apparatus 100 scans a preset number of channels in the channel map. The broadcast receiving apparatus 100 may randomly select some channels among the plurality of channels included in the channel map, or may select channels corresponding to preset channel numbers.

At operation S350, the broadcast receiving apparatus 100 compares the scanned channels with the channel map and determines whether they are matched with each other. That is, the broadcast receiving apparatus 100 determines whether contents of the directly scanned channels are equal to the contents of the channel map. For example, the broadcast receiving apparatus 100 determines whether a channel number of ‘1’ is actually tuned when it is tuned to a frequency of the channel number of ‘1’ recorded in the channel map.

If it is determined that they are equal to each other, at operation S360, the broadcast receiving apparatus 100 determines that the received channel map is valid and stores this channel map. Then, the broadcast receiving apparatus 100 could be tuned to a correct frequency of a desired channel carried by the broadcast signal based on the stored channel map to receive data.

On the other hand, if it is determined that they are different from each other, at operation S370, the broadcast receiving apparatus 100 determines that the received channel map is invalid and deletes this channel map. At operation S380, the broadcast receiving apparatus 100 generates the channel map by the full scanning method and stores the channel map. Alternatively, the broadcast receiving apparatus 100 may display a message to inform a user of a determination result if it is determined that the received channel map is invalid.

Accordingly, the broadcast receiving apparatus 100 determines the validity of the acquired channel map corresponding to the locational information.

In the foregoing embodiment, the broadcast receiving apparatus 100 requests and acquires the locational information corresponding to the IP address from a separate external apparatus, i.e. the location identifying server 310, but not limited thereto. Alternatively, the broadcast receiving apparatus 100 may determine the locational information corresponding to the IP address by itself, and this will be described below.

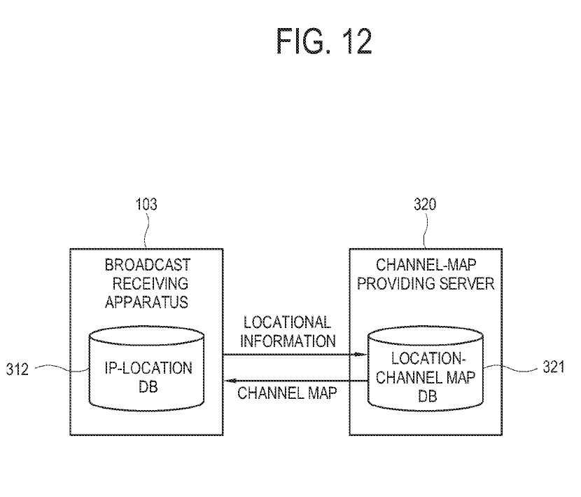

FIG. 12 illustrates data communication between a broadcast receiving apparatus 103 and a channel-map providing server 320 according to an exemplary embodiment.

As shown in FIG. 12, the broadcast receiving apparatus 103 acquires the IP address and communicates with the channel-map providing server 320. The broadcast receiving apparatus 103 of FIG. 12 has substantially the same functions as the broadcast receiving apparatus 100 of the foregoing embodiment except for storing the IP-location DB 312. Further, the channel-map providing server 320 is substantially the same as that of FIG. 9. The IP-location DB 312 and the location-channel map DB 321 are substantially the same as those of FIG. 9, and thus redundant descriptions thereof will be omitted.

When the broadcast receiving apparatus 103 acquires the IP address, it retrieves the IP-location DB 312 stored therein and thus acquires the locational information corresponding to the IP address. The broadcast receiving apparatus 103 transmits the acquired locational information to the channel-map providing server 320.

The channel-map providing server 320 retrieves the channel map corresponding to the locational information of the broadcast receiving apparatus 103 from the location-channel map DB 321. The channel-map providing server 320 transmits the channel map derived by the retrieving result to the broadcast receiving apparatus 103. Thus, the broadcast receiving apparatus 103 stores the channel map received from the channel-map providing server 320.

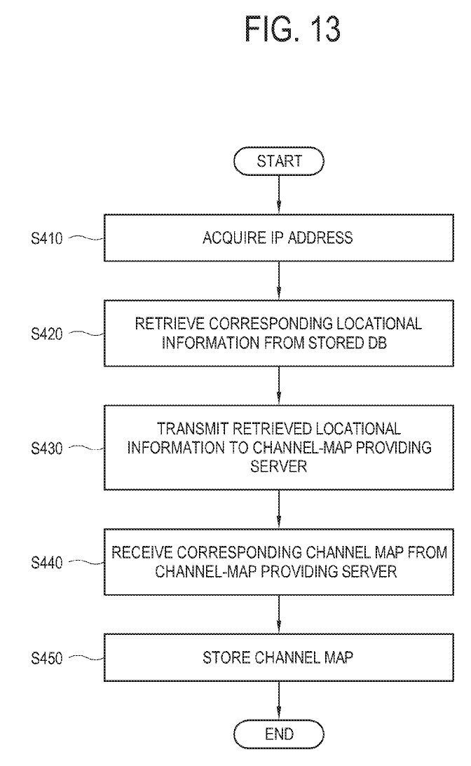

FIG. 13 is a flowchart showing a control method of the broadcast receiving apparatus 103 according to an exemplary embodiment.

As shown in FIG. 13, at operation S410, the broadcast receiving apparatus 103 acquires an IP address to access a network.

At operation S420, the broadcast receiving apparatus 103 retrieves the locational information corresponding to the IP address from the DB stored therein.

At operation S430, the broadcast receiving apparatus 103 transmits the retrieved locational information to the channel-map providing server 320.

At operation S440, the broadcast receiving apparatus 103 receives the channel map corresponding to the locational information from the channel-map providing server.

At operation S450, the broadcast receiving apparatus 103 stores the received channel map.

In the foregoing embodiments, the broadcast receiving apparatus 103 uses the IP address in order to specify a location for acquiring the channel map. However, the method of specifying the location is not limited to the use of the IP address, and the method of acquiring the channel map specified for the location is not limited to the foregoing embodiments.

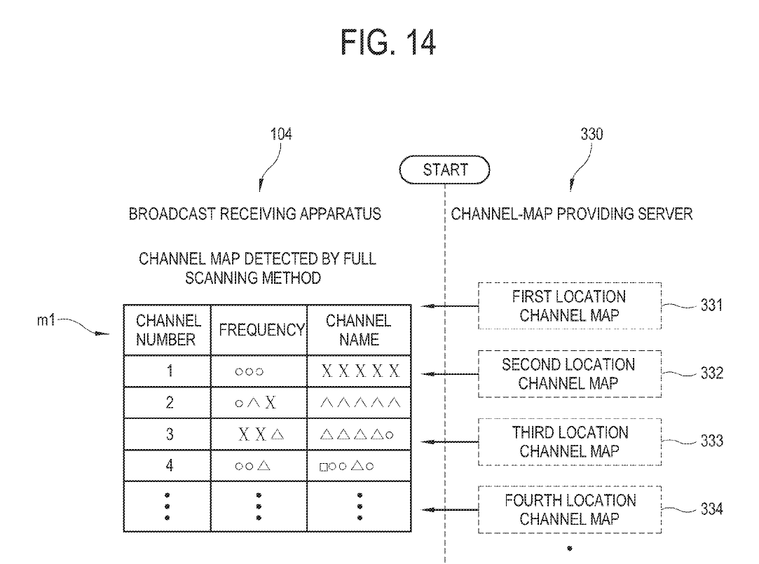

FIG. 14 illustrates a principle of acquiring a channel map in a broadcast receiving apparatus 104 according to an exemplary embodiment.

As shown in FIG. 14, the broadcast receiving apparatus 104 first sends a request of the channel map to the channel-map providing server 330. The channel-map providing server 330 stores channel maps 331, 332, 333 and 334 corresponding to locations, and transmits a plurality of channel maps 331, 332, 333 and 334, instead of only one channel map, to the broadcast receiving apparatus 104 because the request of the broadcast receiving apparatus 104 does not include information of a certain location.

At this time, it is unnecessary to provide all the channel maps stored in the channel-map providing server 330 to the broadcast receiving apparatus 104, and thus channel maps 331, 332, 333 and 334 at least expected to correspond to the location of the broadcast receiving apparatus 104 are selectively transmitted to the broadcast receiving apparatus 104. To this end, various criteria for selecting the channel maps 331, 332, 333 and 334 may be given. For example, the channel-map providing server 330 may not specify small-scale locations of the broadcast receiving apparatus 104, but may specify large-scale locations including the small-scale locations of the broadcast receiving apparatus 104. Thus, the channel-map providing server 330 may select the channel maps 331, 332, 333 and 334 respectively corresponding to the small-scale locations within the corresponding large-scale location.

Further, the broadcast receiving apparatus 104 generates a channel map m1 based on the full scanning method. If the broadcast receiving apparatus 104 receives a plurality of channel maps 331, 332, 333 and 334 from the channel-map providing server 330 while generating the channel map m1, the broadcast receiving apparatus 104 stops generating the channel map m1. In the stopped channel map m1, scanning is completed with regard to a partial portion of the whole effective frequency band of the broadcast signal.

The broadcast receiving apparatus 104 selects one matching with contents of the currently scanned channel map m1 among the plurality of channel maps 331, 332, 333 and 334. Here, the contents of the channel map m1 include at least two among a channel number, a frequency and a channel name. The broadcast receiving apparatus 104 stores the selected one of the channel maps 331, 332, 333 and 334 and may be tuned to a frequency of a desired channel carried by the broadcast signal based on the stored channel map to receive data.

If there are two or more channel maps matching the content of the channel map m1 among the plurality of channel maps 331, 332, 333 and 334, the full scanning and the comparison are resumed to compare the channel map m1 with the remaining channel maps until only one channel map remains.

Thus, the broadcast receiving apparatus 104 can acquire the channel map specified by the location even though the location is not specified by the IP address.

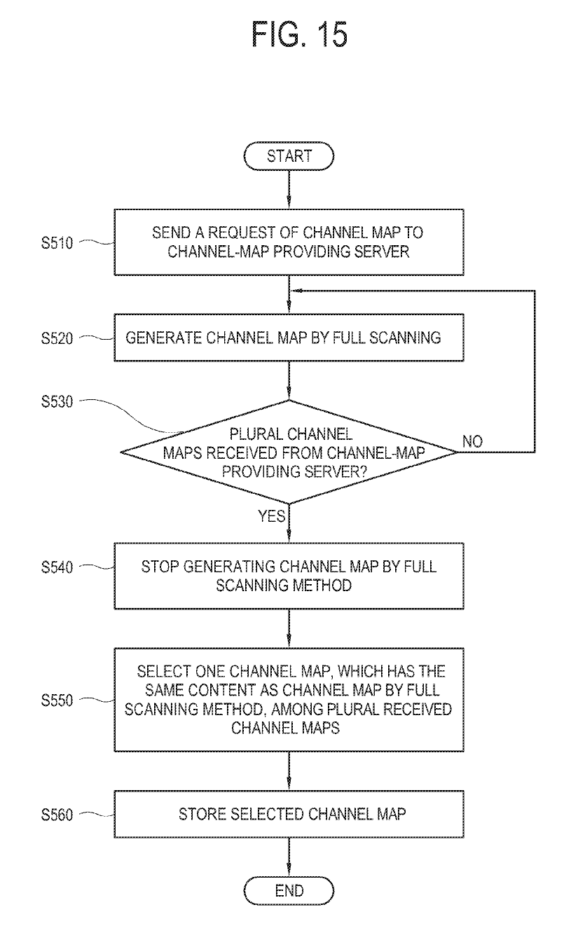

FIG. 15 is a flowchart showing a control method of the broadcast receiving apparatus 104 according to an exemplary embodiment;

As shown in FIG. 15, at operation S510, the broadcast receiving apparatus 104 sends a request of the plurality of channel maps to the channel-map providing server 330. At operation S520, the broadcast receiving apparatus 104 generates a channel map through the full scanning method.

At operation S530, the broadcast receiving apparatus 104 determines whether the plurality of channel maps are received from the channel-map providing server 330. If it is determined that the plurality of channel maps are not received, the broadcast receiving apparatus 104 continues to generate the channel map by the full scanning method.

If it is determined that the plurality of channel maps are received, at operation S540, the broadcast receiving apparatus 104 stops generating the channel map scanned by the full scanning method. At operation S550, the broadcast receiving apparatus 104 selects one channel map, which is equal to the channel map scanned by the full scanning method, among the plurality of channel maps. At operation S560, the broadcast receiving apparatus 104 stores the selected one of the channel maps.

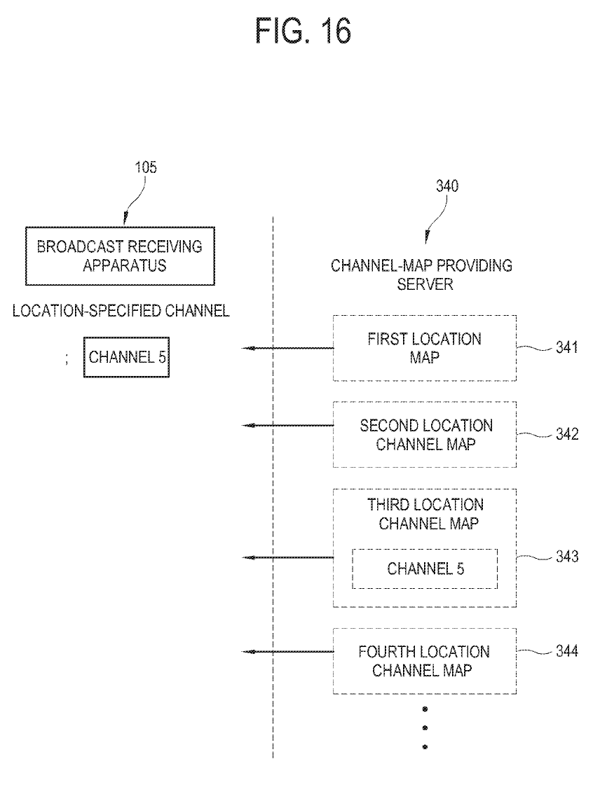

FIG. 16 illustrates a principle of acquiring a channel map in a broadcast receiving apparatus 105 according to an exemplary embodiment;

As shown in FIG. 16, the broadcast receiving apparatus 105 sends a request of a channel map to a channel-map providing server 340. The channel-map providing server 340 stores the channel maps 341, 342, 343 and 344 respectively corresponding to locations, and transmits a plurality of channel maps 341, 342, 343 and 344 to the broadcast receiving apparatus 105 because the request of the broadcast receiving apparatus 105 includes no information of a certain location.

The broadcast receiving apparatus 105 uses the full scanning method to scan the broadcast signal, and detects a location-specified channel during the scanning. The location-specified channel is a channel provided in only a certain location, which is included in the broadcast signal only when the broadcast signal is provided at the corresponding location. That is, if the broadcast receiving apparatus 105 detects the location-specified channel from the broadcast signal by the full scanning method, this location-specified channel is not provided to any location other than the current location of the broadcast receiving apparatus 105, and it is thus determined that the channel map including the location-specified channel corresponds to the broadcast receiving apparatus 105.

Thus, the broadcast receiving apparatus 105 selects one channel map, which has the location-specified channel detected by the full scanning method, among the plurality of channel maps 341, 342, 343 and 344 received from the channel-map providing server 340. For example, the broadcast receiving apparatus 105 selects a third-location channel map 343, which has a channel of ‘5’, among the plurality of channel maps 341, 342, 343 and 344 if the location-specified channel is a channel of ‘5’ detected by the full scanning method.

The broadcast receiving apparatus 105 stores the selected channel map 343, and is tuned to a channel of the broadcast signal based on the stored channel map 343.

In this manner, the broadcast receiving apparatus 105 can acquire the location-specified channel map.

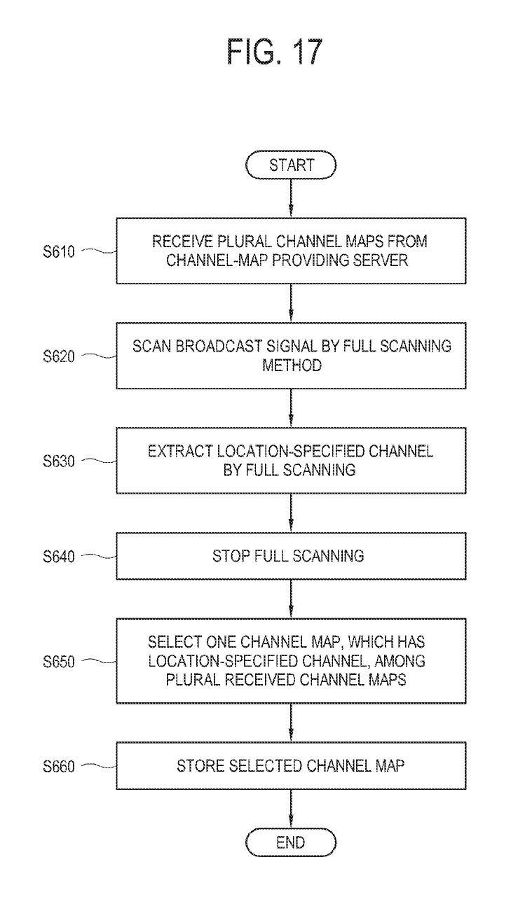

FIG. 17 is a flowchart showing a control method of the broadcast receiving apparatus 105 according to the fifth exemplary embodiment.

As shown in FIG. 17, at operation S610, the broadcast receiving apparatus 105 receives the plurality of channel maps from the channel-map providing server 340. At operation S620, the broadcast receiving apparatus 105 scans the effective frequency band of the broadcast signal by the full scanning method.

At operation S630, the broadcast receiving apparatus 105 extracts the location-specified channel by the full scanning. If the location-specified channel is extracted, at operation S640, the broadcast receiving apparatus 105 stops the full scanning.

At operation S650, the broadcast receiving apparatus 105 selects one channel map, which has the extracted location-specified channel, among the plurality of channel maps received from the channel-map providing server 340. If the plurality of channel maps have the location-specified channel, a separate process may be performed to select one of them.

At operation S660, the broadcast receiving apparatus 105 stores the selected channel map and is tuned to a channel of the broadcast signal based on the stored channel map.

Here, the broadcast receiving apparatus may use various methods to specify the location, and the broadcast receiving apparatus may simultaneously use the plurality of methods to specify the location. By the way, when the broadcast receiving apparatus uses the plurality of methods to specify the location, the respective methods may bring different results. For example, if the location derived by a first method is different from the location derived by a second method, the broadcast receiving apparatus may allow a user to select one of the locations. Below, this will be described.

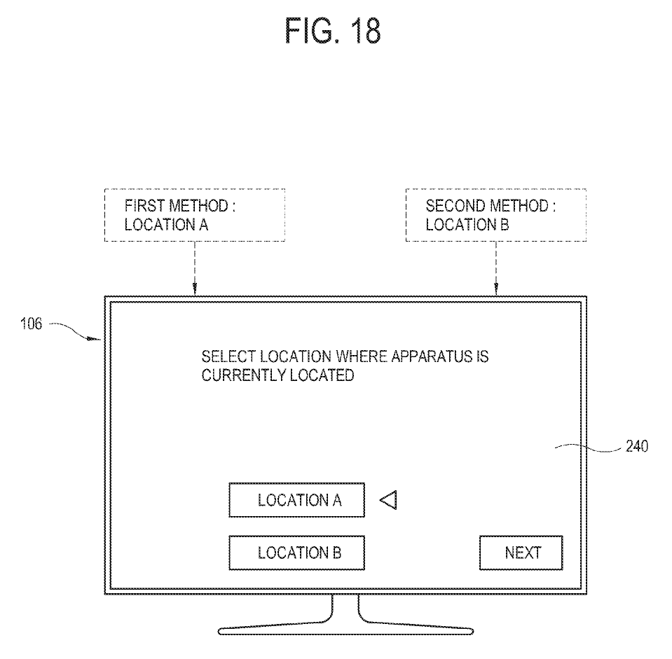

FIG. 18 illustrate a UI 240, which requests a user to select a location, displayed on a broadcast receiving apparatus 106 according to a sixth exemplary embodiment;

As shown in FIG. 18, the broadcast receiving apparatus 106 may detect the locations by the preset first method and the preset second method, respectively. The first method and the second method are different from each other, and may be achieved by various methods.

For example, the first method may detect the location corresponding to the IP address acquired by the broadcast receiving apparatus 106 as described above. The second method may detect the location corresponding to AP related information about the AP to which the broadcast receiving apparatus 106 can access. The first method may be called a GeoIP method, and the second method may be called a GeoLocation method.

According to the second method, when the broadcast receiving apparatus 106 is connected the network through Wi-Fi or the like wireless communication, the broadcast receiving apparatus 106 acquires the AP related information including a media access control (MAC) address of an AP that the broadcast receiving apparatus 106 can access, and acquires the locational information corresponding to the acquired information from the location identifying server.

When the location is specified by the first method, accuracy of national and city units is high, but accuracy of zip code units is relatively low. On the other hand, when the location is specified by the second method, the general accuracy is higher than that of the first method, but accuracy of a certain location, such as a boundary location of administrative address units may be low. Therefore, when the location is specified by each of the first method and the second method, the respective results of specifying the locational may be different.

Thus, if it is determined that the location specified by the first method is different from the location specified by the second method, the broadcast receiving apparatus 106 displays the UI 240 that requests a user to select one of the two locations. If a user selects one location through the UI 240, the broadcast receiving apparatus 106 acquires the channel map corresponding to the selected location.

If it is determined that the location specified by the first method is equal to the location specified by the second method, there is no need of displaying the UI 240 and thus the broadcast receiving apparatus 106 acquires the channel map corresponding to the specified location.

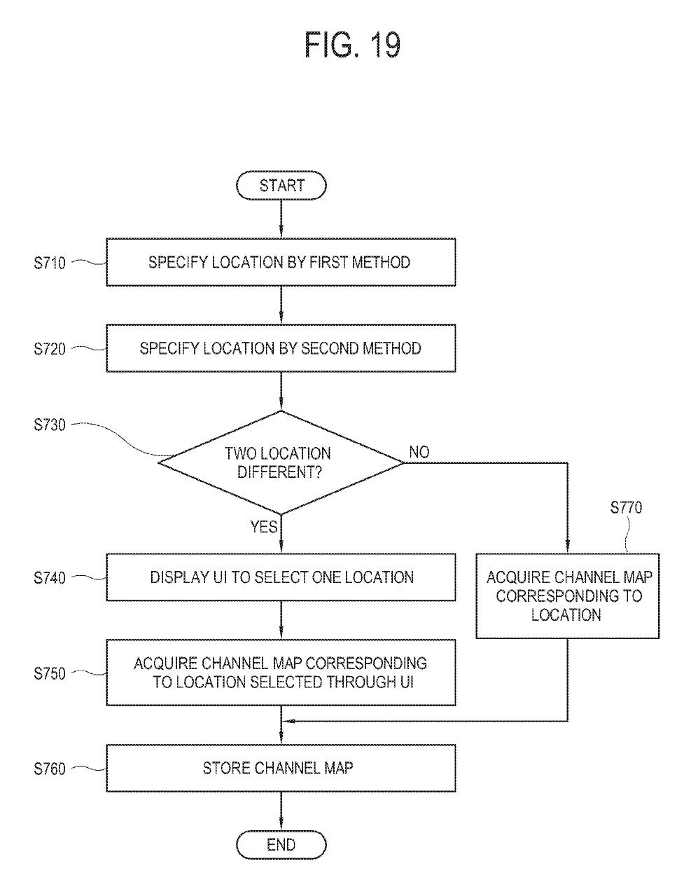

FIG. 19 is a flowchart showing a control method of the broadcast receiving apparatus 106 according to an exemplary embodiment.

As shown in FIG. 19, at operation S710, the broadcast receiving apparatus 106 detects its own location by the preset first method. At operation S720, the broadcast receiving apparatus 106 detects its own location by the preset second method. Here, the first and second methods of detecting ing the location are different from each other.

At operation S730, the broadcast receiving apparatus 106 determines whether the location detected by the first method is different from the location detected by the second method.

If it is determined that two locations are different from each other, at operation S740, the broadcast receiving apparatus 106 displays a UI through which one of the two locations is selected. The broadcast receiving apparatus 106 acquires the channel map corresponding to the location selected by the UI at operation S750, and stores the acquired channel map at operation S760.

On the other hand, if it is determined that two locations are the same, the broadcast receiving apparatus 106 acquires the channel map corresponding to the location at operation S770, and returns to the operation S760.

In the foregoing embodiment, the channel-map providing server provides the channel maps. However, a source from which the broadcast receiving apparatus acquires the channel map is not limited to the channel-map providing server, and the broadcast signal may serve as a carrier of the channel maps. That is, the channel maps may be carried by the broadcast signal transmitted from the transmitter of the broadcasting station to the broadcast receiving apparatus, and this will be described below.

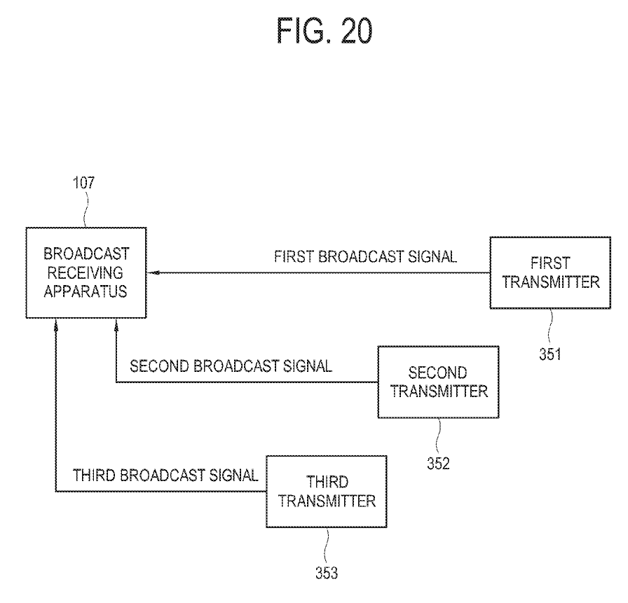

FIG. 20 illustrates that a broadcast receiving apparatus 107 according to an exemplary embodiment receives broadcast signals from respective transmitters 351, 352 and 353 of broadcasting stations.

As shown in FIG. 20, the broadcast receiving apparatus 107 may receive one or more broadcast signals in accordance with locations. For example, the broadcast receiving apparatus 107 may receive a first broadcast signal from a first transmitter 351, a second broadcast signal from a second transmitter 352, and a third broadcast signal from a third transmitter 353. Each of the transmitters 351, 352 and 353 may be provided in one broadcasting station, or may be respectively provided in different broadcasting stations.

The first broadcast signal, the second broadcast signal and the third broadcast signal basically include a plurality of channels, but may additionally include channel map data of the corresponding broadcast signal. In this case, the channel map data of each broadcast signal is provided by the broadcasting station having the transmitters 351, 352 and 353.

Although the plurality of broadcast signals are received, the broadcast receiving apparatus 107 is tuned to one broadcast signal in order to display a broadcast image. Thus, the broadcast receiving apparatus 107 selects one broadcast signal based on a preset selection criterion among the plurality of broadcast signals, and extracts and stores the channel map from the selected broadcast signal. Further, the broadcast receiving apparatus 107 is tuned to and process the corresponding broadcast signal based on the channel map, thereby displaying a broadcast image.

Here, the preset selection criterion for selecting one among the plurality of broadcast signals may be variously varied depending on different design choices. For example, the broadcast receiving apparatus 107 determines reception of the plurality of broadcast signals, and selects the broadcast signal of the best reception. The broadcast signal of the best reception may be a broadcast signal having the highest intensity or a broadcast signal having the lowest noise level.

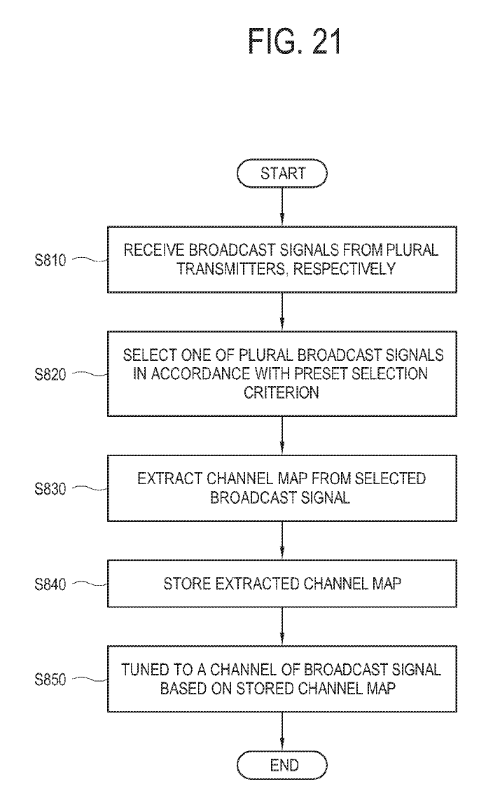

FIG. 21 is a flowchart showing a control method of the broadcast receiving apparatus 107 according to an exemplary embodiment.

As shown in FIG. 21, at operation S810, the broadcast receiving apparatus 107 receives broadcast signals from the plurality of transmitters, respectively.

At operation S820, the broadcast receiving apparatus 107 selects one broadcast signal among the plurality of broadcast signals in accordance with the preset selection criterion.

The broadcast receiving apparatus 107 extracts a channel map from the selected broadcast signal at operation S830, and stores this channel map at operation S840.

At operation S850, the broadcast receiving apparatus 107 is tuned to a channel of the selected broadcast signal based on the extracted channel map.

While the broadcast receiving apparatus 107 selects and is tuned to the broadcast signal as described above, the broadcast receiving apparatus 107 may need to select another broadcast signal according to the selection criterion due to the changing situation of the plurality of broadcast signals. For example, if the second broadcast signal has the highest intensity among the first broadcast signal, the second broadcast signal and the third broadcast signal, the broadcast receiving apparatus 107 extracts the channel map from the second broadcast signal and is tuned to a channel of the second broadcast signal. However, if then the third broadcast signal is changed to have highest intensity, it is advantageous to be tuned to the third broadcast signal rather than the second broadcast signal to display the broadcast image in consideration of broadcast quality.

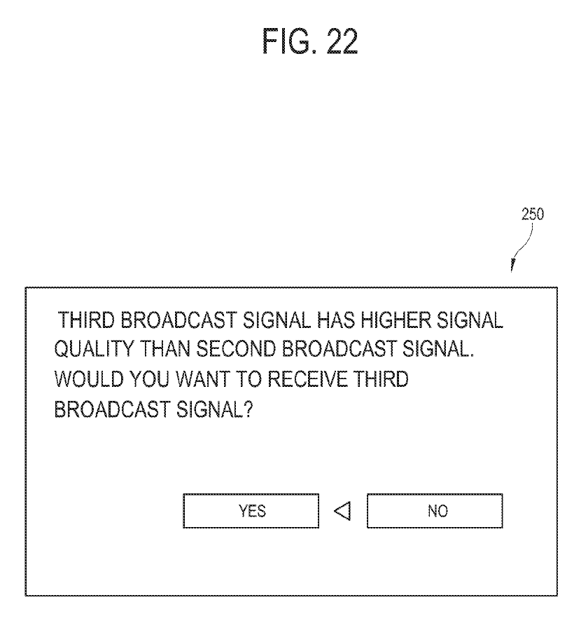

FIG. 22 illustrates a UI 250, which requests a user's approval for change of a broadcast signal, displayed on a broadcast receiving apparatus 107 according to an exemplary embodiment.

As shown in FIG. 22, if it is determined that the third broadcast signal has higher intensity than the previously selected second broadcast signal, the broadcast receiving apparatus 107 displays the UI 250, which request a user's approval for changing from the second broadcast signal to the third broadcast signal.

If a user disapproves any change through the UI 250, the broadcast receiving apparatus 107 maintains the current state of receiving the second broadcast signal.

On the other hand, if a user approves a change through the UI 250, the broadcast receiving apparatus 107 switches to receive the third broadcast signal. The broadcast receiving apparatus 107 extracts the channel map from the third broadcast signal and replaces the previously-stored channel map of the second broadcast signal by the channel map extracted from the third broadcast signal. Then, the broadcast receiving apparatus 107 is tuned to a channel of the third broadcast signal based on the replaced channel map.

While storing the channel map of the third broadcast signal, the broadcast receiving apparatus 107 may delete the previously-stored channel map of the second broadcast signal. Alternatively, the broadcast receiving apparatus 107 may not delete but maintain the channel map of the second broadcast signal in order to prepare for a possible switch back into the second broadcast signal. In this case, if there is a change from the third broadcast signal to the second broadcast signal, the broadcast receiving apparatus 107 uses the previously stored channel map of the second broadcast signal without extracting the channel map from the second broadcast signal.

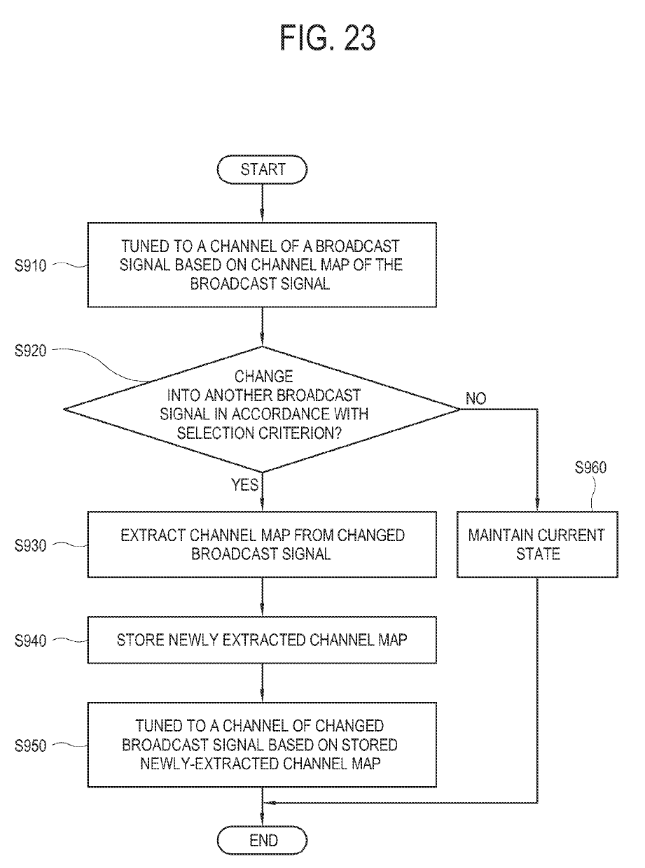

FIG. 23 is a flowchart showing a control method of the broadcast receiving apparatus 107 according to an exemplary embodiment. These operations are performed following the foregoing operations shown in FIG. 21.

As shown in FIG. 23, at operation S910, the broadcast receiving apparatus 107 is turned to a channel of a broadcast signal based on a channel map of the broadcast signal.

At operation S920, the broadcast receiving apparatus 107 determines whether the broadcast signal selected by the preset selection criterion is changed.

If it is determined that there is a change in the broadcast signal, at operation S930, the broadcast receiving apparatus 107 extracts a channel map from a new broadcast signal. At operation S940, the broadcast receiving apparatus 107 stores the newly extracted channel map. At operation S950, the broadcast receiving apparatus 107 is tuned to a channel of the broadcast signal based on the stored channel map.

If it is determined that there is no change in the broadcast signal, at operation S960, the broadcast receiving apparatus 107 maintains the current state.

In addition, the plurality of channel maps may be searched with respect to the location specified by the IP address or the like. That is, when the broadcast receiving apparatus transits the locational information corresponding to the IP address to the channel-map providing server, the plurality of channel maps corresponding to the location information may be retrieved in the channel-map providing server. Below, this embodiment will be described.

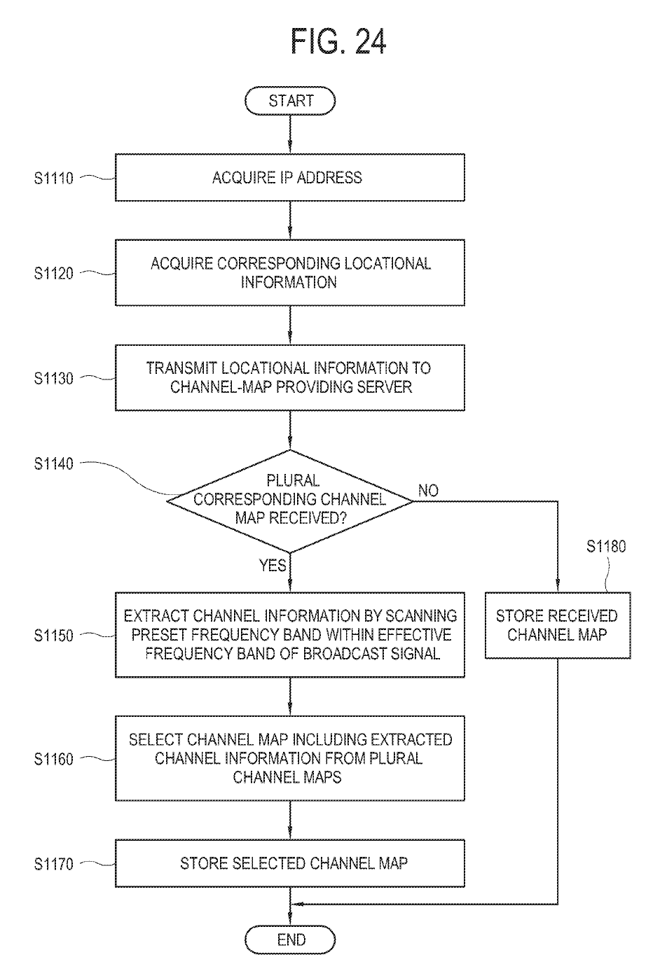

FIG. 24 is a flowchart showing a control method of a broadcast receiving apparatus according to an exemplary embodiment.

As shown in FIG. 24, at operation S1110, the broadcast receiving apparatus acquires an IP address to access a network. At operation S1120, the broadcast receiving apparatus acquires the locational information corresponding to the IP address.

At operation S1130, the broadcast receiving apparatus transmits the locational information to the channel-map providing server.

At operation S1140, the broadcast receiving apparatus determines whether the plurality of channel maps corresponding to the locational information are received from the channel-map providing server.

If the plurality of channel maps are received, at operation S1150, the broadcast receiving apparatus extracts channel information by scanning the preset frequency band within the effective frequency band of the broadcast signal. One or more preset frequency bands may be randomly selected, or a certain frequency band may be previously selected. In the case of randomly selecting on or more present frequency bands, if no channel is retrieved in the corresponding frequency band, the broadcast receiving apparatus may scan another frequency band.

At operation S1160, the broadcast receiving apparatus selects one channel map, which has contents of the extracted channel information, among the plurality of channel maps.

At operation S1170, the broadcast receiving apparatus stores the selected channel map.

On the other hand if it is determined in the operation S1140 that one channel map is received, at operation S1180 the broadcast receiving apparatus stores the received channel map.

On the contrary to the foregoing embodiments, a user may directly input locational information as the method of specifying the location of the broadcast receiving apparatus.

The methods according to the foregoing exemplary embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for materializing the exemplary embodiments. The program command recorded in this storage medium may be specially designed and configured according to the exemplary embodiments, or may be publicly known and available to those skilled in the art of computer software.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcast receiving apparatus comprising:
a signal receiver configured to receive a broadcast signal carrying a plurality of channels;
a communicator configured to communicate with a server, which provides channel information of the broadcast signal according to a plurality of locations;
a storage configured to store the channel information; and
at least one processor configured to determine a location corresponding to the broadcast receiving apparatus, receive the channel information of the broadcast signal corresponding to the determined location through the communicator and store the received channel information in the storage, and receive data from one channel of the plurality of channels carried by the broadcast signal based on the stored channel information.

2. The broadcast receiving apparatus according to claim 1, wherein
the communicator is configured to wirelessly communicate with a communication relay for relaying communication with a network, and
the at least one processor is further configured to determine the location based on access information given from the communication relay to the communicator so that the communicator can access the network.

3. The broadcast receiving apparatus according to claim 2, wherein
the communication relay comprises an access point and a router for relaying wireless communication, and
the access information comprises an Internet protocol (IP) address given from the access point and the router to the broadcast receiving apparatus.

4. The broadcast receiving apparatus according to claim 2, wherein
the at least one processor is further configured to process a user interface (UI) to be displayed for allowing a user to select one of locations identified by the access information.

5. The broadcast receiving apparatus according to claim 1, wherein
the at least one processor is further configured to scan the broadcast signal with regard to a preset number of channels from the received channel information, and stores the channel information in response to the scanning result being equal to the channel information.

6. The broadcast receiving apparatus according to claim 5, wherein
the at least one processor is further configured to generate channel information by fully scanning an effective frequency band of the broadcast signal in response to the scanning result being different from the channel information.

7. The broadcast receiving apparatus according to claim 1, wherein
the at least one processor is further configured to extract channel information by scanning a preset frequency band within an effective frequency band of the broadcast signal in response to receiving a plurality of pieces of the channel information corresponding to the location, and selects one piece of channel information, which has the scanned channel information, among the plurality of pieces of the channel information.

8. The broadcast receiving apparatus according to claim 1, wherein
the at least one processor is further configured to determine the location in response to a user's input.

9. The broadcast receiving apparatus according to claim 1, wherein
the at least one processor determines whether the channel information is received before fully scanning the effective frequency band of the broadcast signal.

10. A control method of a broadcast receiving apparatus, the method comprising:
communicating with a server, which provides channel information of a broadcast signal according to a plurality of locations;
determining a location corresponding to the broadcast receiving apparatus;
receiving the channel information of the broadcast signal corresponding to the determined location and storing the received channel information in the storage; and
receiving data from a channel carried by the broadcast signal based on the stored channel information.

11. The method according to claim 10, wherein the determining the location comprises:
accessing a communication relay for relaying communication with a network; and
determining the location based on access information given from the communication relay so that the broadcast receiving apparatus can have access to the network.

12. The method according to claim 11, wherein
the communication relay comprises an access point and a router for relaying wireless communication, and
the access information comprises an Internet protocol (IP) address given from the access point and the router to the broadcast receiving apparatus.

13. The method according to claim 11, wherein the determining the location comprises:
displaying a user interface (UI) for allowing a user to select one of locations identified by the access information.

14. The method according to claim 10, wherein the receiving and storing the channel information comprises:
scanning the broadcast signal with regard to a preset number of channels from the received channel information; and
storing the channel information in response to the scanning result being equal to the channel information.

15. The method according to claim 14, wherein the receiving and storing the channel information comprises:
generating channel information by fully scanning an effective frequency band of the broadcast signal in response to the scanning result being different from the channel information.

16. The method according to claim 10, wherein the receiving and storing the channel information comprises:
extracting channel information by scanning a preset frequency band within an effective frequency band of the broadcast signal in response to receiving a plurality of pieces of the channel information corresponding to the location; and
selecting one piece of channel information, which has the scanned channel information, among the plurality of pieces of the channel information.
